(19) United States
(12) Patent Application Publication
(10) Pub. No.: US 2004/0200424 A1
(43) Pub. Date: Oct. 14, 2004

(54) Prepackaged litter and litter box system

(76) Inventor: Carl Kenneth Stolpe, Hobe Sound, FL (US)

Correspondence Address: Carl Stolpe, 8349 SE Woodcrest Place, Hobe Sound, FL, 33455, US

(21) Appl. No.: 10/412,538

(22) Filed: Apr. 14, 2003

(51) Int. Cl. A01K 29/00

(52) U.S. Cl. 119/165

(57) ABSTRACT

This is a complete prepackaged litter box system that includes pre-measured sealed plastic bags of litter in a cardboard box contain. The bags of prepackaged litter are measured, in quantity, to provide a sufficient amount of litter for the standard litter box. There are several prepackaged bags in each box container allowing, at minimum, seven complete changes of the bag and litter. Each bag when put in use is unsealed with the removable tie wrap. It is placed in the box where it contains the litter and also serves as a moisture liner to contain the animal waste. The bag when opened spreads the litter in the box and the open end is turned over the four upright edges of the box and is held in place by fitting the top of the box onto the bottom portion of the box. Hence the box container in which the product is shipped is then used as the litter box for the number of prepackaged bags of litter. To change the litter, the bag containing the soiled litter is removed and sealed with a tie wrap and disposed of and the new bag of litter is placed in the box. This system of packaging contains the prepackaged product for shipment and provides disposable plastic bag liners and a disposable litter box, which in its entirety is safely disposed of and is completely sanitary for its use and disposal.

This invention is for a complete system of animal care, a cat, which is a home pet to dispose of the animal's waste. The provision of this system is to have one complete package for the supply of materials for the sanitary disposal of the animal's waste.

This innovation provides a complete system encompassing all of the materials for servicing the animal's needs to capture and to remove the animal waste. This system is very easy to use, it is convenient and it is most importantly sanitary, in that it requires no manual contact with the new litter product or with the used litter and animal waste when being disposed of

Several previous designs for disposable litter boxes do not incorporate the system aspects of this invention. As seen in U.S. Pat. No. 6,487,990 to McNew (2002) and U.S. Pat. No. 6,382,131 to McGivern (2002) these are for specially constructed Collapsible Litter Boxes. This invention provides a system that utilizes a conventional corrugated cardboard container that does not require any assembly and can be used as a litter box and can be disposed of after the use of the several prepackaged bags of litter incorporated into this system

Reference U.S. Pat. No. 4,884,526 to Giannakopoulos (1989) in which this design is for a very specifically arranged litter box configured with an integral bag of litter all for one use. This is quite different than this proposed invention in that this container is designed as a packaged system in which the box container can be used as a litter box. Within the container are several prepackaged bags of litter for use in a litter box. This system offers extended use and is placed in service for a period until all of the litterbags have been used. There would be a minimum of seven prepackaged bags of litter.

Other Patents researched include:

U.S. Pat. Nos. 5,013,282, 5,845,601, 5,590,623, 5,251,573, 5,249,550, 5,211,134, 5,123,381, 5,117,781, 5,115,766, 4,932,360, 4,913,091, 4,807,564, 4,779,567, 4,776,300

These are designs for disposable litter boxes incorporating specially folded and constructed boxes, that may or may not contain one, or in some cases two uses of packaged litter.

The design applied for here is for a complete system of packaging including the box container that may be used as a disposable litter box and several prepackaged litter bags that serve as the packaged portion of litter and also as a moisture containment in the box and as the bag for disposing of the waste and expended litter. All of this is accomplished with convenience for the pet owner in a manner that is clean, sanitary, and with no requirement for handling any of the product or the animal waste or exposure to objectionable odors. This is a new innovation that is not presently available in the market place. And with the number of home pets, namely cats, this convenience and sanitary method for care is most essential for those with increasing time constraints and restrictions on the disposal of the animal waste.

Multi Prepackaged Litter in Plastic Bag Liners

The box container for this system is the packaging for the product and can serve as a litter box for the product. This box container is fitted with a handle, which is integral with the package, to provide ease of handling the somewhat heavy product from the store to an automobile and to the home. The box container is so designed that it can be used as a litter box for the number of prepackaged litterbags packaged within the container. This is a convenience for the pet owner in the home or for a temporary use during travel or any other situation away from the home. The box contains a number of prepackaged plastic bags containing the litter. Each bag when put in use, is opened by removing the tie wrap and is then placed, with its contents of litter, in the bottom section of the box. The bag serves as a liner for the box and to contain the pre-measured amount of litter. After use the bag is closed with a tie-wrap to seal the used litter and animal waste and the bag is disposed of A new bag is then placed into the litter box providing clean litter for the animal. After all of the prepackaged bags have been used the box is disposed of and is replaced with a new box container and new bags of prepackaged litter.

The Benefits Provided by this System Are:

Sanitation: The prepackaged material does not require handling of the litter prior to or after use. The disposable bag requires no contact with the soiled litter or the animal waste. The container for the packaging when used as a litter box does not require cleaning and can be disposed of as any paper product.

Ease of Use: The prepackaged bags are clean and do not require any handling or transport of the litter. This prevents any contact with the litter material and the dust associated with measuring out the material. Each pre-measured bag contains the proper amount for each use when placed in the bottom half of the box. To change the litter one simply gathers the loose portion of the bag, which is draped over the sides of the box, seals the bag with a tie wrap and disposes of the bag. The used litter is in a sealed bag and hence there is no handling of soiled litter and no odor from the waste. A new bag of clean litter is then placed in the box and is ready for use. This system is quick, easy and very clean. This offers the pet owner a convenience, which is not now available in the market place.

Convenience: The container is designed for ease of handling. Since the material is heavy, the complete package is approximately twenty pounds, the package is compact in size and is fitted with a handle for ease of transport. The container is opened by removing the outer sleeve, taking off the top of the box and removing the prepackaged bags of litter and then opening one bag placing it in the bottom of the box and replacing the top of the box which retains the sides if the plastic bag liner. This simple application is repeated for each use until all of the bags of litter have been used.

### DRAWINGS

1. Perspective view of the package as it would be sold in its complete form.

2. The bottom half of the box container, top and side views.

3. The top half of the box container, top and side views.

4. The blank cover which retains the prepackaged litter in the bottom of the box.

5. The sleeve container which carries the printed information and provides a handle for the completed container.

6. Pleated plastic bag dimensioned to fit the bottom half of the box container.

7. Litter box assembly with prepackaged bags inside the bottom portion of the box, cutaway section of the blank cover and the top of the box in place.

8. The box assembled with the plastic bag liner and litter inside. The top of the box serves to retain the plastic bag liner and to provide the opening for the animal. This view shows the litter box prepared for the animal's use.

9. An exploded view of the packaging showing the five components of the package assembly; the bottom, the prepackaged litterbags, the blank cover, the top and the outer wrapper.

FIG. 1 Is a perspective drawing of the packaged system and completed container as offered to the pet owner. This package contains the prepackaged litter in sealed plastic bags for use in the litter box. The packaged system consists of the box container, the prepackaged litterbags and the outer sleeve, which retains the assembled box and is the surface on which all of the printing, instruction for use and a convenience handle for transporting the package is located. The box, as shown in FIGS. 2, 3, and 4 are for the bottom portion, the top portion and a blank cover to retain the packaged litter. When packaged in its complete form the container is secured with the outer sleeve for transport shown in FIG. 1.

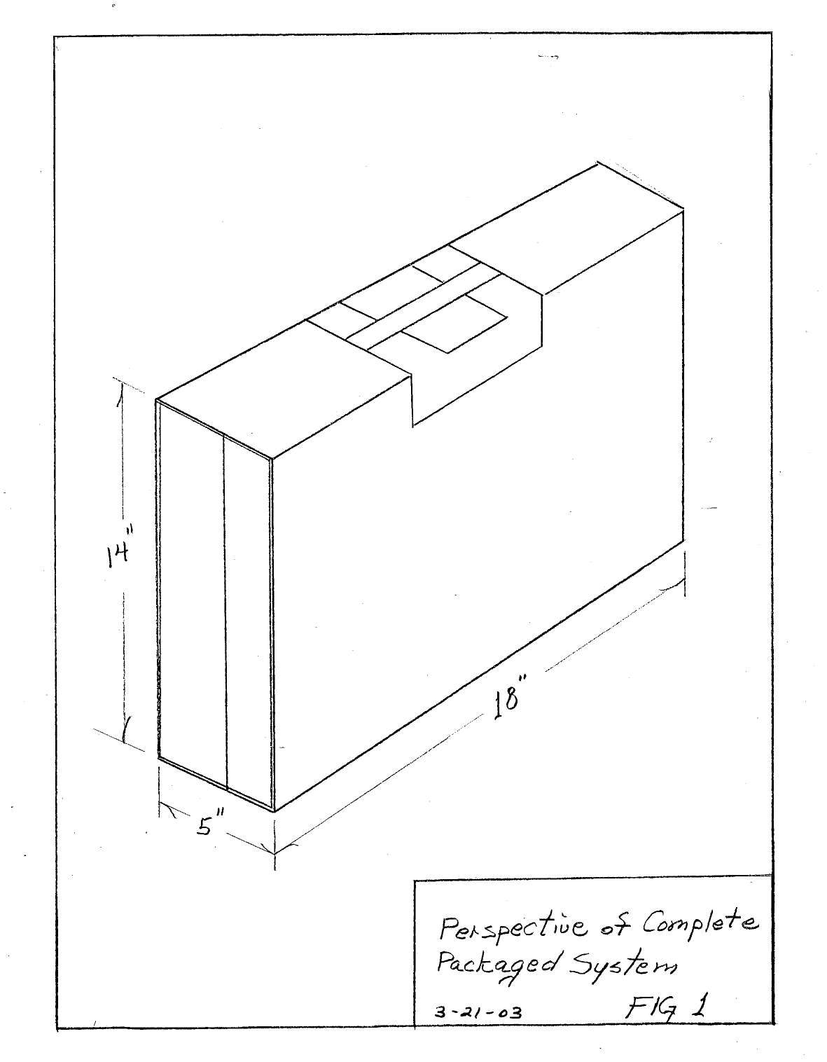

FIG. 2 Is a drawing of the bottom half of the box which is simply a container made of corrugated cardboard which may have the inner surface treated for moisture resistance. The box is assembled to retain the prepackaged litterbags for transport. The box can also be used as the litter box for travel or home use for the number of prepackaged litterbags contained in the box, as sold. The box is disposed of, as recycled paper, when the product has been expended.

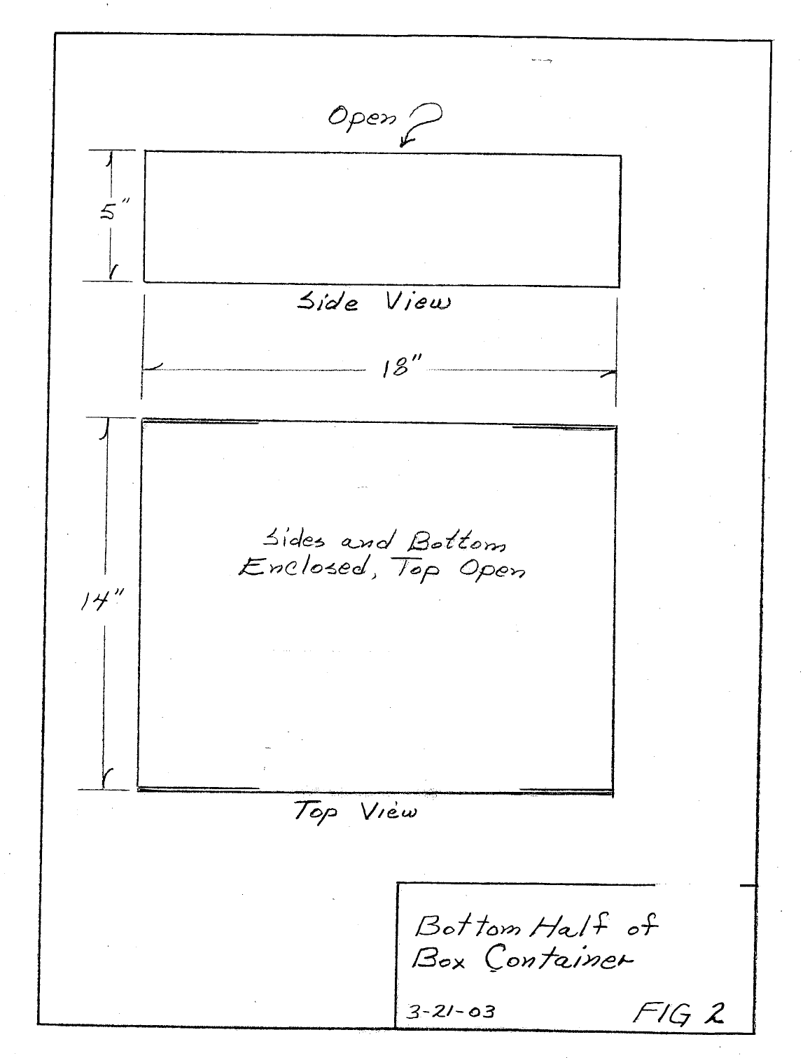

FIG. 3 Is a drawing of the top half of the box. This other half of the container is also made of corrugated cardboard. The top portion has a cutout so that if the box is used as a litter box the top serves to retain the sides of the plastic liner bag and provides the opening for the animal during its use to deposit waste.

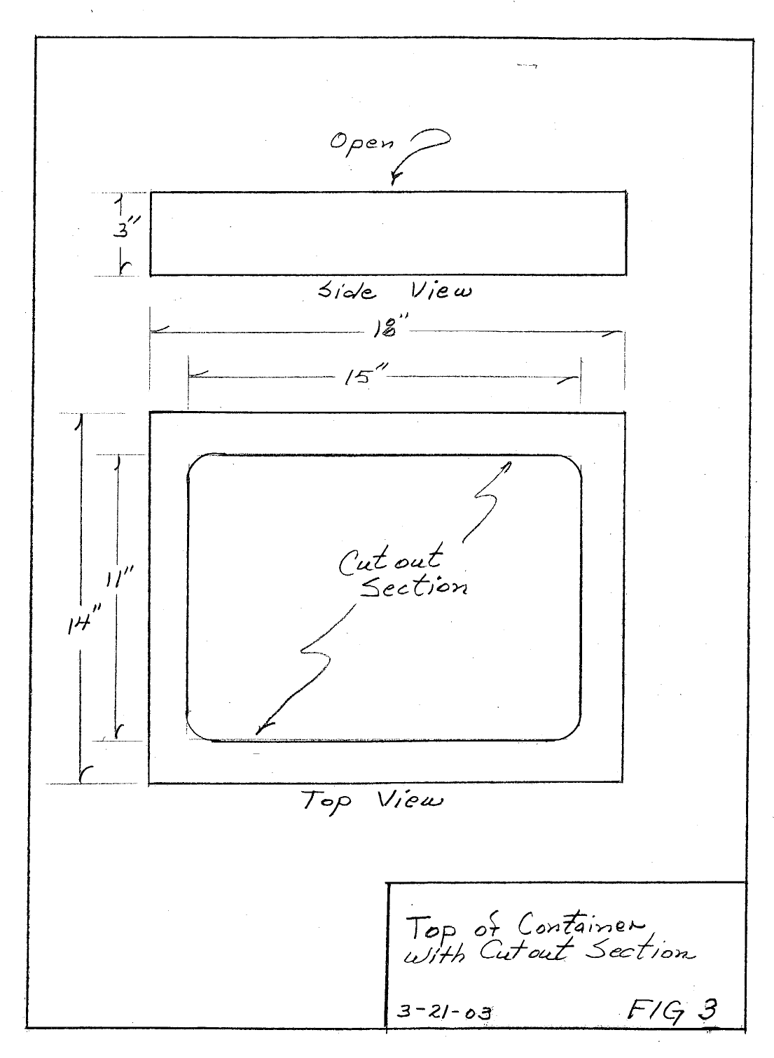

FIG. 4 Is a drawing of the corrugated cardboard blank cover which is placed over the bottom half of the box after the prepackaged litter bags are placed in the box. This simply serves to contain the product in the box after the top half of the box is placed on the bottom half This is required due to the cutout in the top portion of the top of the completed box.

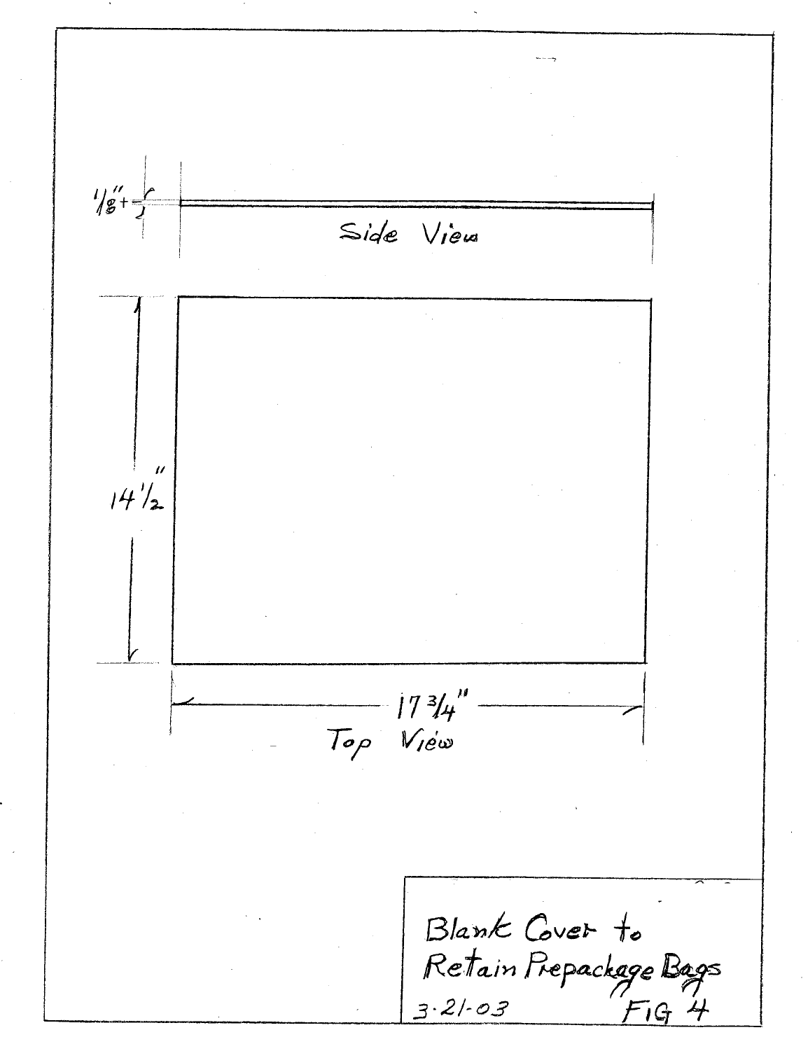

FIG. 5 Is a drawing of the sleeve which retains the completed package. This sleeve serves, when attached in place, to hold the two halves of the box and the product in place for transport. This view is of the sleeve laid flat before assembly around the box container. The sleeve is folded along the designated fold lines and is lapped on the one long side where it is glued to secure the sleeve monolithically. The sleeve also serves as a surface for printed matter, such as the product name, instruction, etc. There is also a built-in handle that can be extracted from the sleeve, providing a convenient and reasonable method to carry the product from the point of sale. Since the completed box containing the prepackaged litter material is heavy, some twenty pounds, this convenience handle is required.

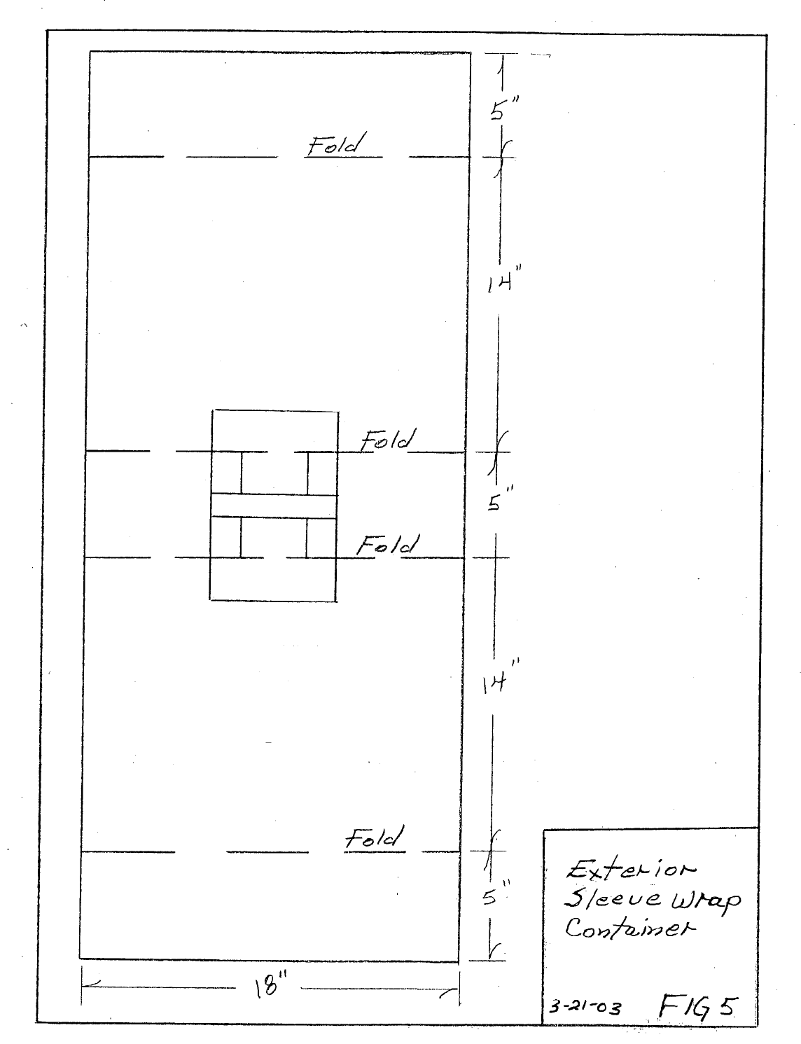

FIG. 6 Is a drawing of the plastic bag designed specifically to contain the litter and to lay flat in the bottom of the litter box. The bag is designed as a pleated bag that opens to the width and length of the litter box and extends over the sides of the box. Each bag contains the litter for one application. The bag is sealed with a tie wrap for transport. When put in use the tie wrap is removed from the bag and the bag is placed in the litter box. The bag serves to retain the litter and the waste from the animal and is a moisture barrier, which retains all of the waste and wet litter. To change the litter, the bag is sealed with a tie wrap and the bag is removed and disposed of A new bag of litter is then placed in the litter box.

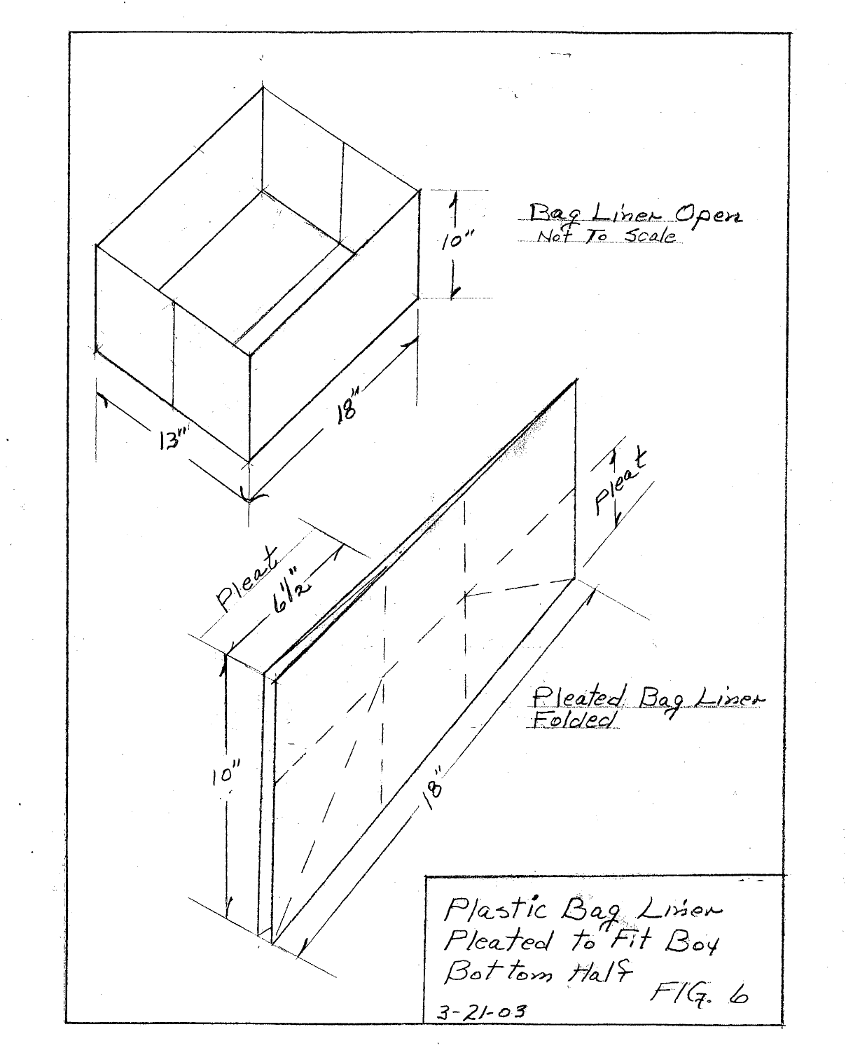

FIG. 7 This drawing shows the box container with the bottom half of the box, the prepackaged litter bags inside, a cutaway of the blank cover and the top of the box in place. This view shows the packaging system before the container is secured with the outer sleeve.

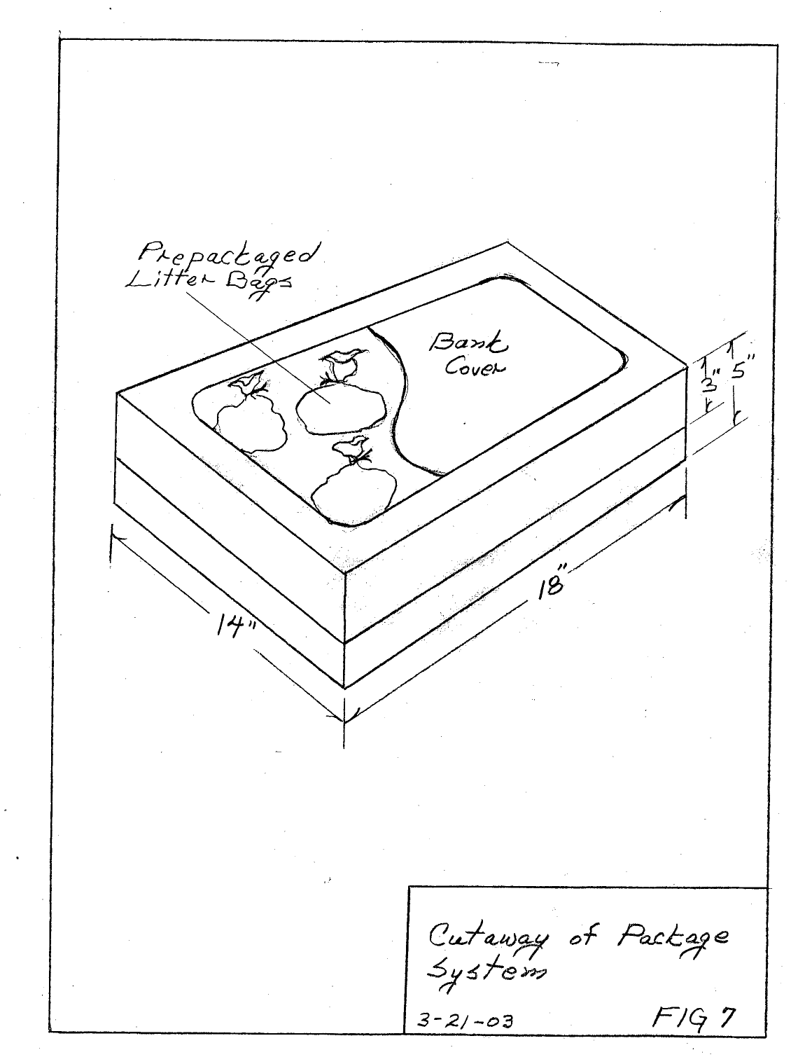

FIG. 8 This drawing shows the assembled box with the litter installed for use by the animal. The prepackaged litterbag is in place in the bottom half of the box, the litter is spread and the ends of the plastic bag are turned over the sides of the box. The top portion of the box is placed over the bottom half to secure the plastic liner and to provide the opening for the animal.

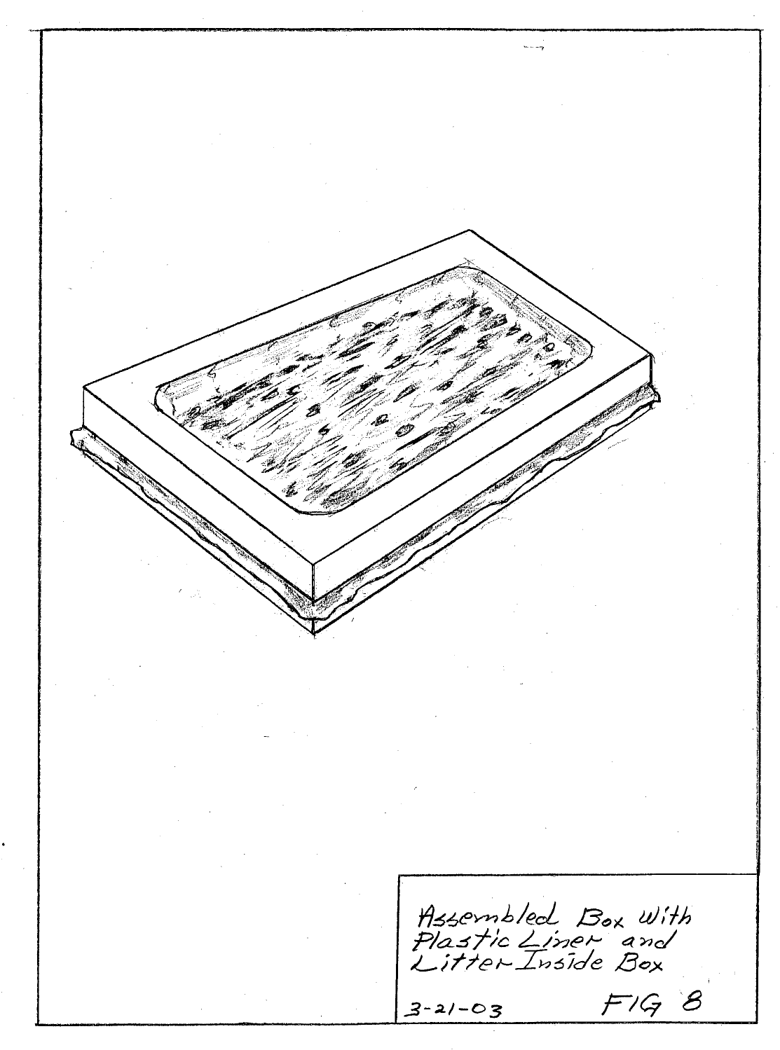

FIG. 9 This is an exploded view showing each component of the completed product packaging as it is placed together and assembled to form the completed product system for transport to the point of sale.

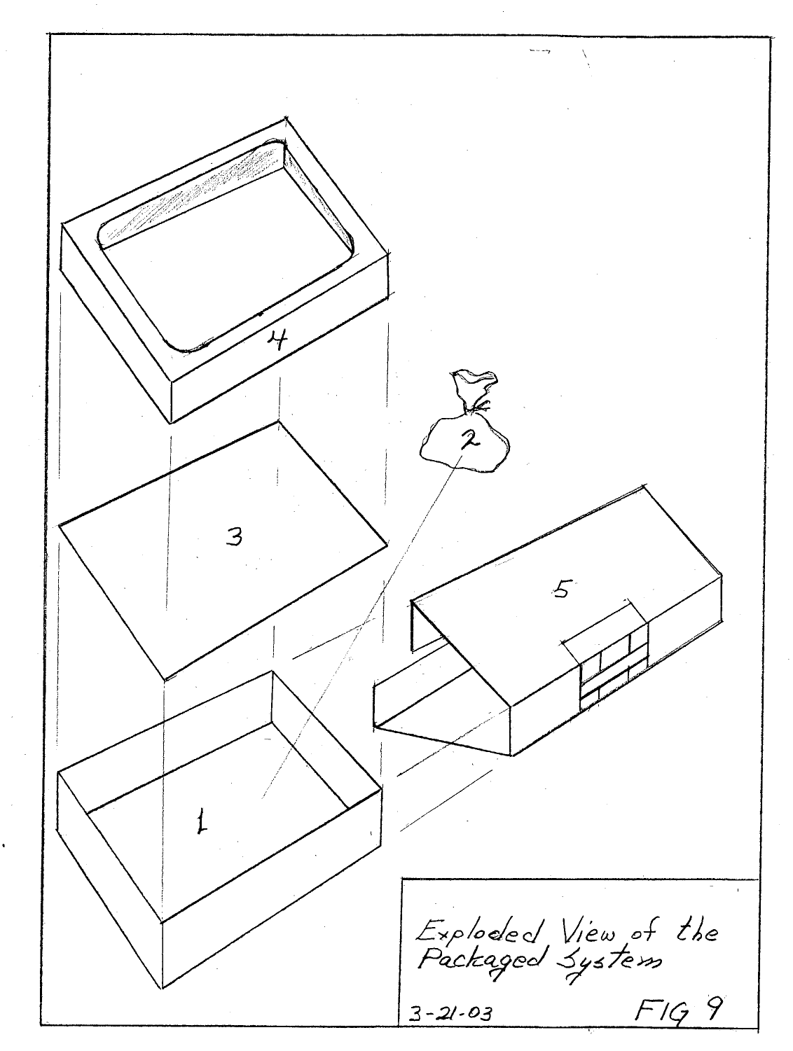

1. This litter box system is a complete method of providing for the disposal of cat animal waste in a domestic environment.
a. The box container is designed to carry the several prepackaged bags of litter in a convenient container size and is configured for easy transport of the product from the store to the home.
b. The container is a simple box design, with an outer wrapper, that serves to contain the entire box and product and provides a handle for carrying the box, much like an attachécase.
c. The box consists of a bottom, a top, a blank cover to retain the bags of product and the outer wrapper which secures the container, provides a carrying handle and is the surface for printing instruction, name identification, etc.
d. The box container is quite easily and conveniently converted into a litter box.
For this use the outer wrapper is removed, the top portion of the box is taken off, the blank cover is removed and all of the prepackaged bags of litter are removed. The box container, with the top and bottom portions, is then a standard size litter box.
e. Each prepackaged bag of litter is pre-measured and sealed with a tie wrap. The box container is utilized by placing one of the bags of litter in the bottom portion of the box, removing the tie wrap from the bag and turning the loose ends of the plastic bag over the four sides of the bottom portion of the box. The top of the box is then put in place and it secures the plastic bag to the sides of the box.
f. When this container is assembled with the litterbag installed and secured with the top of the box in place, it is an adequate size litter box for the animal's use. It is a neat and clean place for the animal to deposit waste in a moisture resistant and sanitary envelope containing the litter.
g. This system provides a clean, sanitary method for servicing the litter box. The prepackaged litterbag is convenient and easy to install. The plastic bag is configured to fit the dimensions of the bottom portion of the box. The plastic bag serves as a liner to contain the litter and the animal waste. The bag is easily removed by gathering the loose portion of the bag, sealing the bag with a tie wrap and disposing of the bag containing the animal waste. There is no contact with the litter or with the waste. By sealing the bag there is no unpleasant handling of the soiled litter or any unpleasant odor from the animal waste.

2. The litter is prepackaged and pre-measured in plastic bags that are sealed with a tie wrap. The bags are used in the litter box to contain the litter, provide a moisture barrier and serve as the receptacle for disposal.
a. The prepackaged bags of litter contain the proper amount of the absorbent type litter, such as bentonite clay, to sufficiently cover the bottom of the litter box.
b. The bags are of a pleated design so they lay flat in the bottom of the litter box.
c. The bags can also be furnished in a normal flat bag configuration.
d. The bag is prepackaged with a pre-measured amount of litter and is then sealed with a tie wrap.
e. Each bag, when installed in the litter box, is placed in the bottom portion of the box, the tie wrap is removed and the top portion of the bag is turned over the outer edges of the box. The top of the box is then placed over the bottom box and serves to retain the edges of the bag in place.
f. The bag retains the litter and provides a moisture barrier protecting the bottom of the box. When it is time to replace the litter, the plastic bag is gathered and sealed with a tie wrap. The bag containing the animal waste and used litter is then removed from the litter box and disposed of.
g. This system of prepackaged litter provides a convenient and sanitary method of caring for animal waste not presently available in the market place. With the time constrains placed upon most pet owners this system offers important assistance in time and sanitation.

3. The box container is a convenient and compact package for the prepackaged bags of litter. It is easy to carry and can be used as a litter box for travel or in the home.
a. The box is a conventional corrugated cardboard box consisting of a top, a bottom, a flat blank piece and an outer wrapper.
b. The top and bottom portions are dimensioned as a common rectangular box. The bottom portion is fitted with several prepackaged bags of litter. A blank cardboard cover is placed over the bags to secure them in the bottom box. The top portion of the box is fitted over the bottom portion of the box. A cardboard sleeve wrapper is then secured around the top and bottom portions of the container.
c. When the container package is complete with the packaged product and the sleeve wrapper in place it can be carried by the consumer using the convenient handle, which is integrated into the exterior wrapper.
d. This complete system of packaging including several prepackaged bags of litter provides exceptional convenience to the consumer in the care of their pet. It is inclusive of several changes of litter. The sanitary prepackaging offers clean and healthy litter box maintenance. And the system is entirely disposable and requires no cleaning of the litter box after use since it is disposable and recyclable.
